(19) United States
(12) Patent Application Publication
(10) Pub. No.: US 2022/0222846 A1
(43) Pub. Date: Jul. 14, 2022

(54) INFORMATION PROCESSING APPARATUS, INFORMATION PROCESSING METHOD, AND PROGRAM

(71) Applicant: SONY GROUP CORPORATION, TOKYO (JP)

(72) Inventor: TATSUKI KASHITANI, TOKYO (JP)

(21) Appl. No.: 17/609,846

(22) PCT Filed: Mar. 25, 2020
(86) PCT No.: PCT/JP2020/013280

§ 371 Date: Nov. 9, 2021

(30) Foreign Application Priority Data
May 20, 2019 (JP) 2019-094332

(51) Int. Cl. G06T 7/70

(52) U.S. Cl. CPC G06T 7/70; G06T 2207/20081; G06T 2207/30244

(57) ABSTRACT

[Object] To provide an information processing apparatus, an information processing method, and a program that are capable of estimating a direction from a captured image.

[Solving Means] An information processing apparatus of the present technology includes a controller. The controller acquires a captured image and estimates a zenith direction in the captured image on the basis of the captured image.

### TECHNICAL FIELD

The present technology relates to an information processing apparatus, an information processing method, and a program. Specifically, the present technology relates to a technique of estimating a direction using machine learning.

### BACKGROUND ART

Conventionally, image processing has been a technique required for performing image conversion and deformation and extracting information of feature amounts or the like. For example, Patent Literature 1 discloses an image processing method using a gravity vector detected by an IMU mounted on a smartphone.

Further, Patent Literature 2 discloses an image processing method of automatically determining the vertical direction of a photographic image represented by digital data. This method is strongly desired by business operators who provide a commercial service to keep a medium on which images captured by a digital camera are recorded as they are or a negative film that has been used, from a customer, to align the direction of the series of captured images, record them on a recording medium, and provide the recording medium to the customer or display the images on a homepage.

### CITATION LIST

### Patent Literature

Patent Literature 1: Japanese Patent No. 6100380

Patent Literature 2: Japanese Patent Application Laid-open No. 2004-086806

### DISCLOSURE OF INVENTION

### Technical Problem

As described above, there is a need for a technique of estimating a predetermined direction in an image from a captured image.

In view of the above circumstances, the present technology provides an information processing apparatus, an information processing method, and a program that are capable of estimating a direction from a captured image.

### Solution to Problem

In order to solve the above problem, an information processing apparatus according to an embodiment of the present technology includes a controller.

The controller acquires a captured image.

The controller estimates a zenith direction in the captured image on the basis of the captured image.

The controller may estimate the zenith direction in the captured image by applying the captured image to a learner.

The controller may calculate an evaluation value that is a reliability of the estimated zenith direction.

The controller may execute image processing using the estimated zenith direction when the evaluation value is less than a predetermined threshold value.

The controller may calculate the zenith direction in the captured image on the basis of a captured image captured by an imaging unit, and an acceleration and an angular velocity of a detection unit that are detected by the detection unit during imaging of the imaging unit, and may generate learning data in which the calculated zenith direction and the captured image are associated with each other.

The controller may estimate the zenith direction in the captured image by applying the captured image to the learner, the learner being generated by applying the learning data to a machine learning algorithm.

The controller may update an internal parameter of the learner by supervised learning using the calculated zenith direction as teacher data.

The controller may estimate vector coordinates of the zenith direction.

In order to solve the above problem, an information processing method according to an embodiment of the present technology includes: acquiring a captured image; and estimating a zenith direction in the captured image on the basis of the captured image.

In order to solve the above problem, a program according to an embodiment of the present technology causes an information processing apparatus to execute the following steps of: acquiring a captured image; and estimating a zenith direction in the captured image on the basis of the captured image.

### BRIEF DESCRIPTION OF DRAWINGS

FIG. 1 is a block diagram showing a hardware configuration example of an information processing system according to the present technology.

FIG. 2 is a functional block diagram showing a configuration example of the information processing system.

FIG. 3 is a flowchart showing a typical operation flow of an information processing apparatus of the information processing system.

FIG. 4 is a flowchart showing in detail one step of an information processing method for the information processing apparatus.

FIG. 5 is a flowchart showing in detail one step of the information processing method for the information processing apparatus.

FIG. 6 is a block diagram schematically showing a processing procedure of a general specialized AI.

FIG. 7 is a conceptual diagram showing a network configuration of an MLP.

FIG. 8 is a flowchart showing in detail one step of the information processing method for the information processing apparatus.

### MODE(S) FOR CARRYING OUT THE INVENTION

Hereinafter, an embodiment of the present technology will be described with reference to the drawings.

<Hardware Configuration of Information Processing System>

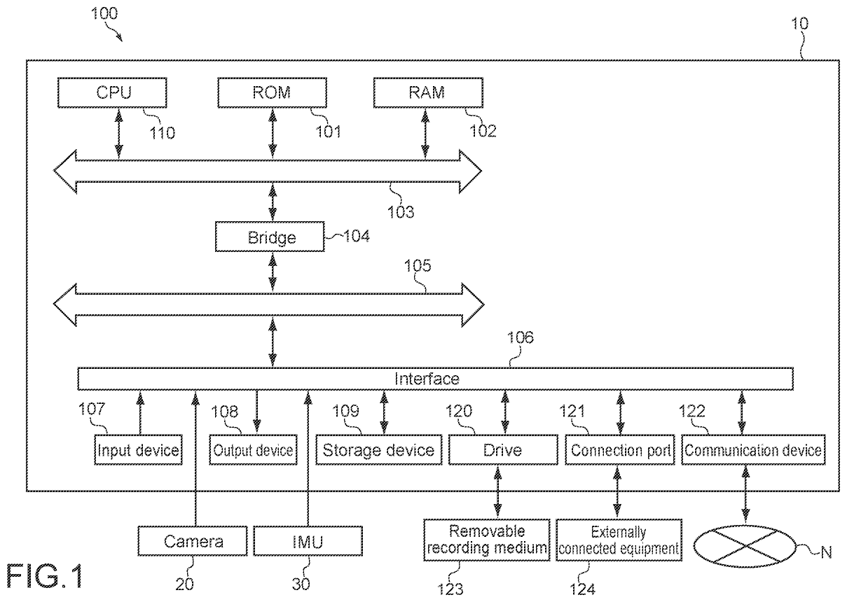

FIG. 1 is a block diagram showing a hardware configuration example of an information processing system 100 according to this embodiment. As shown in FIG. 1, the information processing system 100 includes an information processing apparatus 10, a camera 20, and an inertial measurement unit (IMU) 30.

[Information Processing Apparatus]

The information processing apparatus 10 includes a central processing unit (CPU) 110, a read only memory (ROM) 101, and a random access memory (RAM) 102.

The information processing apparatus 10 may also include a host bus 103, a bridge 104, an external bus 105, an interface 106, an input device 107, an output device 108, a storage device 109, a drive 120, a connection port 121, and a communication device 122.

Further, the information processing apparatus 10 may include a processing circuit such as a digital signal processor (DSP), an application specific integrated circuit (ASIC), a field-programmable gate array (FPGA), or a graphics processing unit (GPU) instead of or together with the CPU 110.

The CPU 110 functions as an arithmetic processing unit and a controller, and controls the overall operation of the information processing apparatus 10 or a part thereof in accordance with various programs recorded in the ROM 101, the RAM 102, the storage device 109, or on a removable recording medium 123. The CPU 110 is an example of a “controller” in Claims.

The ROM 101 stores the programs, calculation parameters, and the like to be used by the CPU 110. The RAM 102 temporarily stores the programs to be used in the execution of the CPU 110, parameters that appropriately change in the execution of the programs, and the like.

The CPU 110, the ROM 101, and the RAM 102 are interconnected by the host bus 103 including an internal bus such as a CPU bus. In addition, the host bus 103 is connected via a bridge 104 to the external bus 105 such as a peripheral component interconnect/interface (PCI) bus.

The input device 107 is a device operated by a user, such as a mouse, a keyboard, a touch panel, a button, a switch, or a lever. The input device 107 may be, for example, a remote control device using infrared rays or other radio waves, or may be externally connected equipment 124 such as a mobile phone corresponding to the operation of the information processing apparatus 10.

The input device 107 includes input control circuits for generating input signals on the basis of information input by the user and outputting the generated input signals to the CPU 110. By operating the input device 107, the user inputs various types of data to the information processing apparatus 10 or instructs the information processing apparatus 10 to perform processing operations.

The output device 108 is configured by a device capable of notifying the user of the acquired information by using senses such as a sense of vision, a sense of hearing, and a sense of touch. The output device 108 may be, for example, a display device such as a liquid crystal display (LCD) or an organic electro-luminescence (EL) display, a sound output device such as a speaker or headphones, or a vibrator.

The output device 108 outputs the result acquired by the processing of the information processing apparatus 10 as a video such as a text or an image, a sound such as voice or audio, or vibration.

The storage device 109 is a data storage device configured as an example of a storage unit of the information processing apparatus 10. The storage device 109 is configured by, for example, a magnetic storage device such as a hard disk drive (HDD), a semiconductor storage device, an optical storage device, or a magneto-optical storage device. The storage device 109 stores, for example, programs to be executed by the CPU 110, various types of data, and various types of data externally acquired.

The drive 120 is a reader/writer for the removable recording medium 123 such as a magnetic disk, an optical disc, a magneto-optical disk, or a semiconductor memory, and is built in or externally attached to the information processing apparatus 10. The drive 120 reads the information recorded on the removable recording medium 123 mounted thereon, and outputs the read information to the RAM 102. Further, the drive 120 writes a record on the removable recording medium 123 mounted thereon.

The connection port 121 is a port for connecting a device to the information processing apparatus 10. The connection port 121 may be, for example, a universal serial bus (USB) port, an IEEE1394 port, or a small computer system interface (SCSI) port.

Further, the connection port 121 may be an RS-232C port, an optical audio terminal, a high-definition multimedia interface (HDMI) (registered trademark) port, or the like. The externally connected equipment 124 is connected to the connection port 121, and thus various types of data can be exchanged between the information processing apparatus 10 and the externally connected equipment 124.

The communication device 122 is, for example, a communication interface including a communication device for connecting to the network N, or the like. The communication device 122 may be, for example, a communication card for a local area network (LAN), Bluetooth (registered trademark), Wi-Fi, or wireless USB (WUSB).

Further, the communication device 122 may be a router for optical communication, a router for asymmetric digital subscriber line (ADSL), or modems for various types of communication. The communication device 122 transmits and receives signals and the like to and from the Internet or other communication devices by using a predetermined protocol such as TCP/IP.

Furthermore, the network N connected to the communication device 122 is a network connected in a wired or wireless manner and may include, for example, the Internet, a home LAN, infrared communication, radio wave communication, and satellite communication.

The information processing apparatus 10 of this embodiment may be any device such as an on-vehicle device, a consumer electronics (CE) device, a wearable device, a mobile device, a robotic device, or a device including a sensor attached to a facility or the like. Further, the information processing apparatus 10 may be any computer such as a server or a PC.

[Camera]

The camera 20 is, for example, an imaging device such as a complementary metal oxide semiconductor (CMOS) or a charge coupled device (CCD), and a device for imaging a real space, using various members such as a lens for controlling formation of a subject image onto the imaging device, and generating a captured image.

The camera 20 may capture a still image or may capture a moving image. The camera 20 is an example of an “imaging unit” in Claims.

[IMU]

The IMU 30 is an inertial measurement unit in which a gyro sensor, an acceleration sensor, a magnetic sensor, a pressure sensor, and the like are combined on a plurality of axes. The IMU 30 is an example of a “detection unit” in Claims.

The IMU 30 detects its own acceleration and angular velocity, and outputs the sensor data thus obtained to the information processing apparatus 10. Note that there is no particular limitation on the location where the IMU 30 is installed in the information processing system 100, and the IMU 30 may be installed in the camera 20, for example. In this case, the CPU 110 can also convert the acceleration and angular velocity obtained from the IMU 30 into the acceleration and angular velocity of the camera 20 on the basis of the position and posture relationship between the camera 20 and the IMU 30.

Hereinabove, an example of the hardware configuration of the information processing system 100 has been described. Each of the components described above may be configured using a general-purpose member or may be configured by hardware specializing in the function of each component. Such a configuration may be changed as appropriate in accordance with the technical level at the time of implementation.

<Functional Structure of Information Processing System>

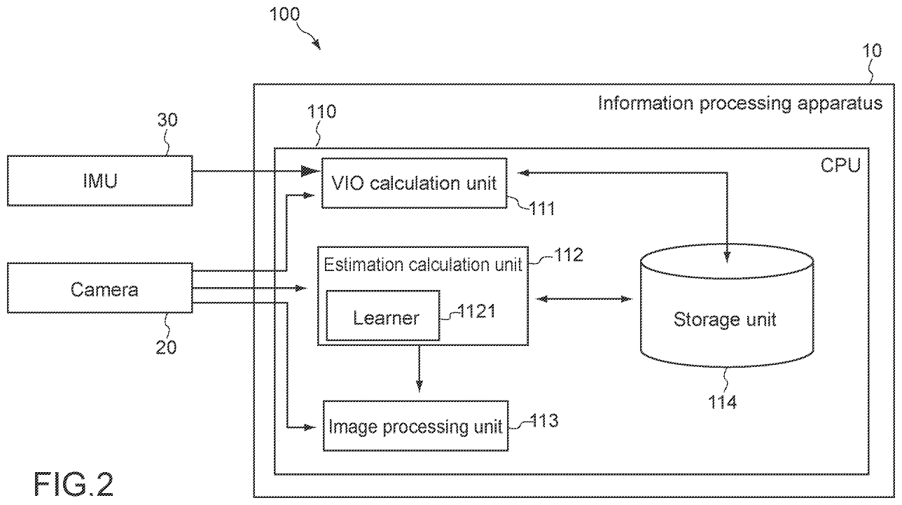

FIG. 2 is a functional block diagram showing a configuration example of the information processing system 100. The information processing apparatus 10 (CPU 110) functionally includes a visual inertial odometry (VIO) calculation unit 111, an estimation calculation unit 112, an image processing unit 113, and a storage unit 114.

The VIO calculation unit 111 estimates the position and posture of the camera 20 in the global coordinate system on the basis of the captured image acquired from the camera 20 and the sensor data acquired from the IMU 30 (acceleration and angular velocity of the IMU 30), and calculates a zenith direction based on the global coordinate system in the captured image from the estimated position and posture of the camera 20. The VIO calculation unit 111 then calculates a zenith direction based on a camera coordinate system of the captured image from the above-mentioned zenith direction. Here, the “zenith direction” is a vertical upward direction, and the same applies to the following description.

The estimation calculation unit 112 estimates the zenith direction by applying the captured image acquired from the camera 20 to a learner. The image processing unit 113 executes predetermined image processing using the zenith direction estimated by the estimation calculation unit 112.

The storage unit 114 stores the calculation results calculated by the VIO calculation unit 111 and the estimation calculation unit 112, the estimation result estimated by the estimation calculation unit 112, and the like. For example, the information of the estimated zenith direction is stored in association with the captured image, or the information of the zenith direction is stored in the tag or metadata of the image information.

The storage unit 114 also stores camera calibration data for calibrating the camera 20 and IMU calibration data for calibrating the IMU 30. Those pieces of calibration data are, for example, data for alleviating individual differences between models. The storage unit 114 may be stored in the ROM 101, the RAM 102, the storage device 109, or on the removable recording medium 123.

Note that the functions of the VIO calculation unit 111, the estimation calculation unit 112, the image processing unit 113, and the storage unit 114 are not limited to those described above, and the detailed functions thereof will be described in an information processing method to be described below.

<Information Processing Method>

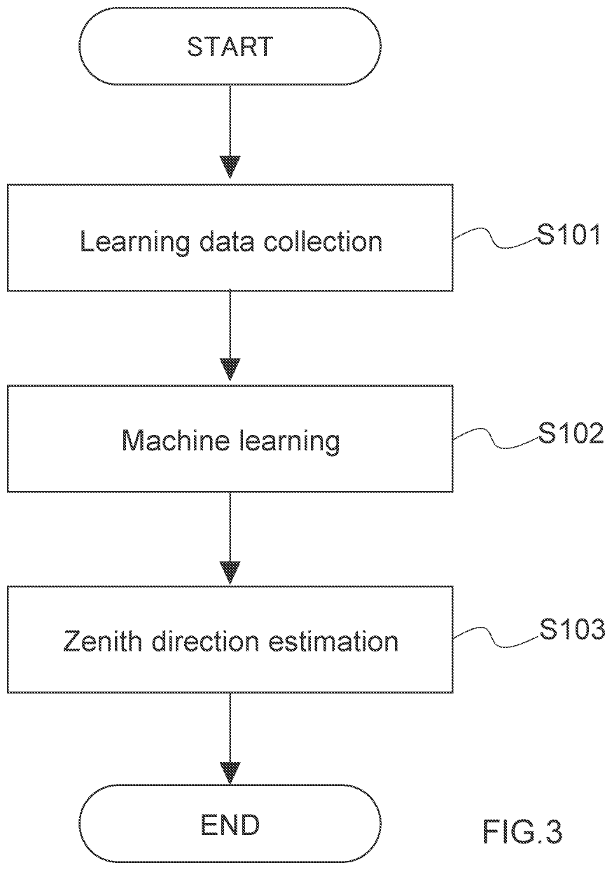

FIG. 3 is a flowchart showing a typical operation flow of the information processing apparatus 10. Hereinafter, an information processing method for the information processing apparatus 10 will be described with reference to FIG. 3 as appropriate.

[Step S101: Learning Data Collection]

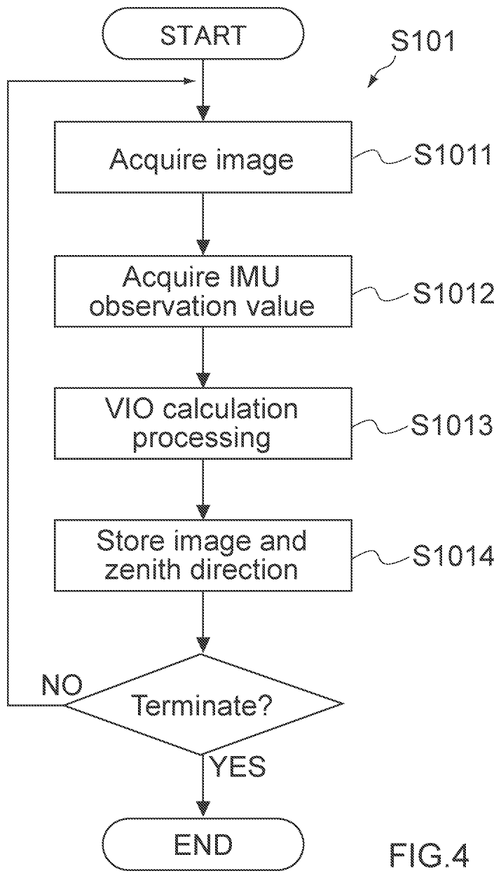

FIG. 4 is a flowchart showing in detail Step S101. Hereinafter, Step S101 will be described with reference to FIG. 4 as appropriate.

First, the VIO calculation unit 111 acquires a captured image captured at a predetermined frame rate (e.g., several tens of fps) from the camera 20 (Step S1011). Further, the VIO calculation unit 111 acquires, for example, sensor data sensed several hundreds of times per second from the IMU 30 (Step S1012) and acquires the camera calibration data and the IMU calibration data from the storage unit 114.

Next, the VIO calculation unit 111 combines the captured image and the sensor data detected at the time of imaging of that captured image (acceleration and angular velocity of the IMU 30), estimates the position and posture of the camera 20 in the global coordinate system by using the visual inertial odometry technology, and calculates the zenith direction based on the global coordinate system in the captured image from the estimated position and posture of the camera 20. For more information on the visual inertial odometry, see the website below (https://en.wikipedia.org/wiki/Visual_odometry).

Subsequently, the VIO calculation unit 111 converts the coordinates of the zenith direction calculated with reference to the global coordinate system into the coordinates of the zenith direction based on the camera coordinate system. At that time, the zenith direction based on the camera coordinate system is calculated as the coordinate information of the three-dimensional unit vector, for example. In this case, such coordinate information may be represented by a rectangular coordinate system (x, y, z), or may be represented by a coordinate system in which one direction in the three-dimensional space is specified with an azimuth angle of 0° to 360° and an elevation angle of −90° to +90°. Note that in this specification the “zenith direction” means coordinate information of a three-dimensional unit vector based on the camera coordinate system.

Next, the VIO calculation unit 111 associates the calculated zenith direction with the captured image linked to that zenith direction, and outputs them to the storage unit 114. As a result, the storage unit 114 stores data in which the captured image is associated with the zenith directions at the moment (Step S1014). Such data is used as learning data in Step S102 to be described below.

[Step S102: Machine Learning]

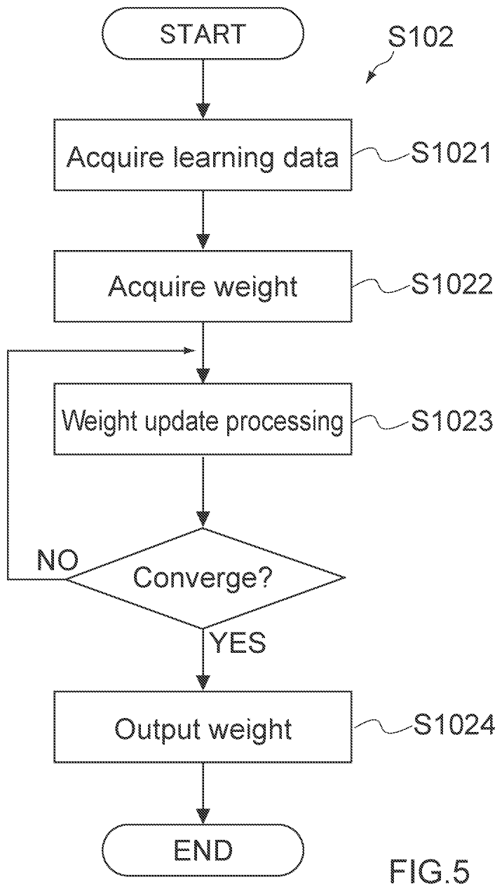

FIG. 5 is a flowchart showing in detail Step S102. Hereinafter, Step S102 will be described with reference to FIG. 5 as appropriate.

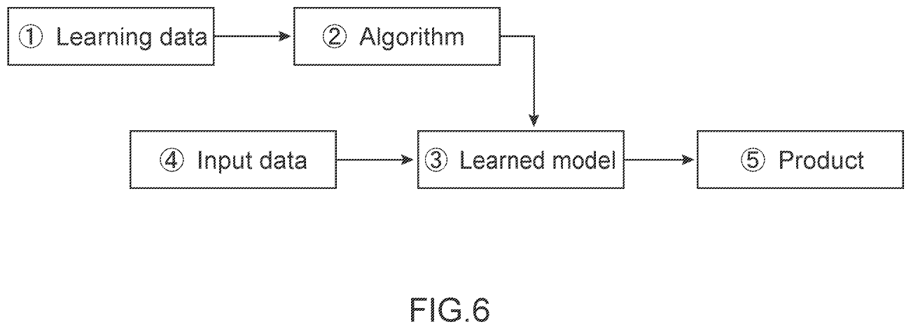

The information processing apparatus 10 of this embodiment is an information processing apparatus using a so-called specialized artificial intelligence (AI) that replaces the intelligent task of the user. FIG. 6 is a schematic diagram schematically showing a processing procedure of a general specialized AI.

The specialized AI is, as a large framework, a mechanism in which a product is obtained by applying any input data to a learned model constructed by incorporating learning data into an algorithm functioning as a learning program.

The estimation calculation unit 112 reads data, in which the captured image and the zenith direction are associated with each other, from the storage unit 114 (Step S1021). Such data corresponds to “learning data” in FIG. 6.

Next, the estimation calculation unit 112 generates a learner by applying the learning data read from the storage unit 114 (the data in which the captured image and the zenith direction are associated with each other) to a preset algorithm. Note that the algorithm described above corresponds to the “algorithm” in FIG. 6, and functions as a machine learning algorithm, for example. Further, the learner corresponds to the “learned model” in FIG. 6.

The type of the machine learning algorithm is not particularly limited, and the machine learning algorithm may be an algorithm using a neural network such as recurrent neural network (RNN), convolutional neural network (CNN), generative adversarial network (GAN), or multilayer perceptron (MLP). In addition, the machine learning algorithm may be any algorithm of executing a supervised learning method (boosting method, support vector machine (SVM) method, support vector regression method (SVR) method, or the like), an unsupervised learning method, a semi-supervised learning method, a reinforcement learning method, or the like.

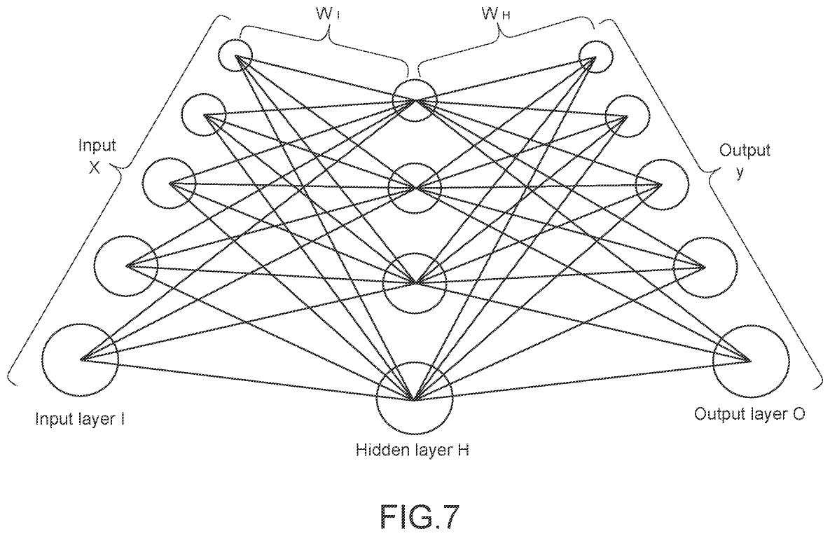

In this embodiment, the MLP and its extension, the CNN, are typically employed as algorithms used for constructing the learner. FIG. 7 is a conceptual diagram showing a network configuration of the MLP.

The MLP is a type of neural network. It is known that any nonlinear function can be approximated by a three-layer neural network if there are an infinite number of neurons in a hidden layer H, and the MLP is conventionally a three-layer neural network in many cases. Therefore, in this embodiment, a case where the MLP is a three-layer neural network will be described as an example.

The estimation calculation unit 112 acquires the coupling weight of the three-layer neural network stored in the storage unit 114 (Step S1022), and applies the coupling weight to a sigmoid function to generate a learner. Specifically, assuming that an input stimulus to the i-th neuron Iᵢ in an input layer I is xᵢ and the coupling weight of Iᵢ and the j-th neuron of the hidden layer H is θ_{Iji}, an output zⱼ of the hidden layer H is expressed by the following equation (1), for example.

$$\begin{matrix}[ Math . 1 ] & \\ {z}_{j} = sigmoid ( {\sum }_{i} {θ}_{lji} {x}_{i} ) & ( 1 )\end{matrix}$$

The “sigmoid” is a sigmoid function and is expressed by the following equation (2). When a=1, it is a standard sigmoid function.

$$\begin{matrix}[ Math . 2 ] & \\ sigmoid ( x ) = \frac{1}{1 + exp ( - ax )} & ( 2 )\end{matrix}$$

Similarly, an output signal yₖ of the k-th neuron in an output layer O is expressed by the following equation (3), for example. Note that when the output space of the output layer O is taken as the entire real values, the sigmoid function of the output layer O is omitted.

$$\begin{matrix}[ Math . 3 ] & \\ {y}_{k} = sigmoid ( {\sum }_{j} {θ}_{Hkj} {z}_{j} ) & ( 3 )\end{matrix}$$

Here, the expression for each element using in the equations (1) and (3) is expressed more simply by applying a sigmoid function for each dimension. Specifically, assuming that the input signal, the hidden layer signal, and the output signal are represented by vectors of x, y, and z, respectively, and the coupling weight on the input signal and the coupling weight on the hidden layer output are represented by W_{I}=[θ_{Iji}] and W_{H}=[θ_{Hkj}], respectively, the output signal y, i.e., the learner is represented by the following equation (4). W_{I} and W_{H} are the internal parameters (weights) of the three-layer neural network.

$$\begin{matrix}[ Math . 4 ] & \\ y = f ( x ; {W}_{l} , {W}_{H} ) = {W}_{H} sigmoid ( {W}_{l} x ) & ( 4 )\end{matrix}$$

Since the supervised learning is typically employed in Step S102 of this embodiment, the estimation calculation unit 112 executes processing of updating the learner until the output error is minimized (Step S1023). Specifically, the estimation calculation unit 112 sets the captured image and zenith direction constituting the learning data to be an input signal and a teacher signal (teacher data), respectively, and updates the internal parameters W_{I} and W_{H} until the error between the output signal obtained by applying the input signal to the equation (4) and the teacher signal converges. The estimation calculation unit 112 outputs the internal parameters W_{I(min)} and W_{H(min)} in which the error is minimized to the storage unit 114 (Step S1024).

[Step S103: Zenith Direction Estimation]

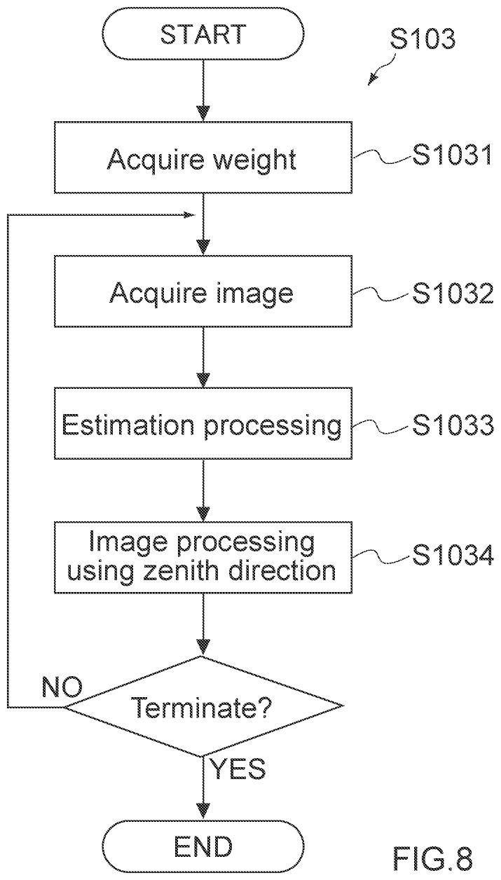

FIG. 8 is a flowchart showing in detail Step S103. Hereinafter, Step S103 will be described with reference to FIG. 8 as appropriate.

The estimation calculation unit 112 reads the internal parameters W_{I(min)} and W_{H(min)} stored in the storage unit 114 (Step S1031) and applies them to the equation (4) to construct the learner 1121. As a result, the estimation calculation unit 112 has a configuration including the learner 1121. At that time, the estimation calculation unit 112 reads the camera calibration data from the storage unit 114 together with the internal parameters W_{I(min)} and W_{H(min)}.

Next, the estimation calculation unit 112 acquires the captured image captured at a predetermined frame rate (e.g., several tens of fps) from the camera 20 (Step S1032). Such a captured image corresponds to the “input data” in FIG. 6.

Subsequently, the estimation calculation unit 112 estimates the zenith direction in the acquired captured image by applying the learner 1121 to the captured image acquired in the previous Step S1032, and outputs the zenith direction to the image processing unit 113 (Step S1033). At that time, the estimation calculation unit 112 may calculate an evaluation value representing the reliability of the estimated zenith direction together with the zenith direction.

The evaluation value is, for example, a real number in the range of 0 to 1. When the zenith direction is estimated with an accuracy of 100% from an observation image having a sufficient amount of information, “1” is given to the zenith direction. On the other hand, for example, when the zenith direction is estimated with an accuracy of 0% from an observation image in which a white wall, a ceiling, or the like appears on the entire image, “0” is given to the zenith direction. Note that the zenith direction estimated in Step S103 correspond to the “product” in FIG. 6.

Next, the image processing unit 113 determines whether the evaluation value given to the zenith direction acquired from the estimation calculation unit 112 is equal to or larger than a predetermined threshold value. Note that the threshold value may be arbitrarily set according to the specifications and applications of the information processing apparatus 10.

If it is determined that the evaluation value is equal to or larger than a predetermined threshold value by the image processing unit 113, image processing using the estimated zenith direction is executed (Step S1034). Specifically, for example, the description of feature amounts or the image processing using the estimated zenith direction as an eigen direction vector for rotating the image patch in pre-processing for object recognition is executed. On the other hand, if it is determined that the evaluation value is less than a predetermined threshold value by the image processing unit 113, the use of the estimated zenith direction is interrupted.

<Functions and Effects>

In the present technology, learning data is collected by the information processing system 100 including the camera 20 and the IMU 30, and the information processing apparatus 10 performs machine learning on the learning data, so that the information processing apparatus 10 estimates the zenith direction only from the captured image. Thus, if the information processing apparatus 10 including the learner 1121 is applied to a device including only a camera, the device can estimate the zenith direction.

As a result, for example, the mounting posture of a fixed camera can be estimated without using the IMU. Furthermore, since the IMU is unnecessary in estimating the zenith direction, not only the simplification and weight reduction of the device configuration, but also the reduction in device cost due to the elimination of the IMU is also achieved.

Further, even in the device mounted with the IMU, if the information processing apparatus 10 including the learner 1121 is applied thereto, it is possible to save the time and labor for calibrating the posture relationship between the IMU and the camera, performing measurement, and securing rigidity. Furthermore, the processing load is suppressed by allowing the zenith direction to be estimated only from the captured image.

In addition, the information processing apparatus 10 of this embodiment not only estimates the zenith direction from only the captured image, but also executes image processing using the estimated zenith direction. Thus, for example, when a feature amount vector describing a feature point in an image is calculated, the estimated zenith direction can be used as a reference orientation that is more invariant than the intrinsic orientation calculated from images around the feature point.

<Modifications>

Although the embodiment of the present technology has been described above, the present technology is not limited to the embodiment described above, and of course various modifications may be made thereto.

For example, although the learning data is generated by the visual inertial odometry technology in Step S101 of the embodiment described above, the present technology is not limited thereto. For example, the learning data may be generated by using a Kalman filter or a Madgwick filter.

Further, in Step S102 of the embodiment described above, when the internal parameters W_{I(min)} and W_{H(min)} are calculated, the noise, the angle of view, the change to the center of an image, and the like of the camera 20 may be subjected to data augmentation.

Further, in the embodiment described above, the case where the MLP is a three-layer neural network has been described as an example, but the present technology is not limited thereto, and a neural network other than the three-layer neural network may be used. For example, the algorithm used to construct the learner may be a two-layer perceptron or a four-layer or more neural network.

In addition, in the embodiment described above, the function employed to construct the learner is a sigmoid function, but the present technology is not limited thereto, and a function other than the sigmoid function, such as a step function or a ReLU function (ramp function), may be employed.

<Supplement>

The embodiment of the present technology may include, for example, the information processing apparatus as described above, a system, an information processing method executed by the information processing apparatus or the system, a program for causing the information processing apparatus to function, and a non-transitory, tangible medium on which the program is recorded.

Further, the present technology may be applied to, for example, an arithmetic device integrated with an image sensor, an image signal processor (ISP) for pre-processing camera images, general-purpose software for processing the image data acquired from cameras, storages, or networks, or a mobile object such as a drone, and the application of the present technology is not particularly limited.

In addition, the effects described herein are illustrative or exemplary only and not restrictive. In other words, the present technology may provide other effects apparent to those skilled in the art from the description herein, in addition to or instead of the effects described above.

Although the suitable embodiment of the present technology has been described in detail above with reference to the accompanying drawings, the present technology is not limited to such an example. It is clear that persons who have common knowledge in the technical field of the present technology could conceive various alterations or modifications within the scope of the technical idea described in the Claims. It is understood that of course such alterations or modifications also fall under the technical scope of the present technology.

Note that the present technology can have the following configurations.

(1) An information processing apparatus, including

a controller that
acquires a captured image, and
estimates a zenith direction in the captured image on the basis of the captured image.

(2) The information processing apparatus according to (1), in which

the controller estimates the zenith direction in the captured image by applying the captured image to a learner.

(3) The information processing apparatus according to (1) or (2), in which

the controller calculates an evaluation value that is a reliability of the estimated zenith direction.

(4) The information processing apparatus according to (3), in which

the controller executes image processing using the estimated zenith direction when the evaluation value is less than a predetermined threshold value.

(5) The information processing apparatus according to any one of (2) to (4), in which

the controller
calculates the zenith direction in the captured image on the basis of a captured image captured by an imaging unit, and an acceleration and an angular velocity of a detection unit that are detected by the detection unit during imaging of the imaging unit, and
generates learning data in which the calculated zenith direction and the captured image are associated with each other.

(6) The information processing apparatus according to (5), in which

the controller estimates the zenith direction in the captured image by applying the captured image to the learner, the learner being generated by applying the learning data to a machine learning algorithm.

(7) The information processing apparatus according to (5) or (6), in which

the controller updates an internal parameter of the learner by supervised learning using the calculated zenith direction as teacher data.

(8) The information processing apparatus according to any one of (1) to (7), in which

the controller estimates vector coordinates of the zenith direction.

(9) An information processing method, including:

acquiring a captured image; and

estimating a zenith direction in the captured image on the basis of the captured image.

(10) A program causing an information processing apparatus to execute the steps of:

acquiring a captured image; and

estimating a zenith direction in the captured image on the basis of the captured image.

### REFERENCE SIGNS LIST

information processing apparatus 10
camera 20
IMU 30
information processing system 100
CPU 110
VIO calculation unit 111
estimation calculation unit 112
image processing unit 113
storage unit 114
learner 1121

1. An information processing apparatus, comprising
a controller that
acquires a captured image, and
estimates a zenith direction in the captured image on a basis of the captured image.

2. The information processing apparatus according to claim 1, wherein
the controller estimates the zenith direction in the captured image by applying the captured image to a learner.

3. The information processing apparatus according to claim 2, wherein
the controller calculates an evaluation value that is a reliability of the estimated zenith direction.

4. The information processing apparatus according to claim 3, wherein
the controller executes image processing using the estimated zenith direction when the evaluation value is less than a predetermined threshold value.

5. The information processing apparatus according to claim 2, wherein
the controller
calculates the zenith direction in the captured image on a basis of a captured image captured by an imaging unit, and an acceleration and an angular velocity of a detection unit that are detected by the detection unit during imaging of the imaging unit, and
generates learning data in which the calculated zenith direction and the captured image are associated with each other.

6. The information processing apparatus according to claim 5, wherein
the controller estimates the zenith direction in the captured image by applying the captured image to the learner, the learner being generated by applying the learning data to a machine learning algorithm.

7. The information processing apparatus according to claim 5, wherein
the controller updates an internal parameter of the learner by supervised learning using the calculated zenith direction as teacher data.

8. The information processing apparatus according to claim 1, wherein
the controller estimates vector coordinates of the zenith direction.

9. An information processing method, comprising:
acquiring a captured image; and
estimating a zenith direction in the captured image on a basis of the captured image.

10. A program causing an information processing apparatus to execute the steps of:
acquiring a captured image; and
estimating a zenith direction in the captured image on a basis of the captured image.
